(19) United States
(12) Patent Application Publication
(10) Pub. No.: US 2025/0101644 A1
(43) Pub. Date: Mar. 27, 2025

(54) PLANAR HEAT-GENERATING KNITTED FABRIC, AND PLANAR HEAT-GENERATING BODY

(71) Applicant: SEIREN CO., LTD., Fukui (JP)

(72) Inventors: Yoshiki TAKEUCHI, Fukui (JP); Kosuke MIYAZAKI, Fukui (JP); Shigekazu SUGIHARA, Fukui (JP)

(21) Appl. No.: 18/728,102

(22) PCT Filed: Oct. 17, 2022
(86) PCT No.: PCT/JP2022/038591

§ 371 Date: Jul. 11, 2024

(30) Foreign Application Priority Data
Jan. 13, 2022 (JP) 2022-003495

(51) Int. Cl. D04B 1/16; D02G 3/12; D02G 3/36; D02G 3/38; D02G 3/44; H05B 3/34

(52) U.S. Cl. CPC D04B 1/16; D02G 3/12; D02G 3/36; D02G 3/38; D02G 3/441; H05B 3/345; D10B 2331/04; D10B 2401/062; D10B 2403/012; D10B 2505/00

(57) ABSTRACT

This planar heat-generating knitted fabric 10 comprises a knitted fabric including conductive yarns 400 as a heat-generating portion, wherein the conductive yarn 400 has a core yarn 410, and a conductive sheath yarn 420 wrapped around the core yarn 410, the conductive sheath yarn 420 is a metal wire covered with an insulating resin 422, the knitted fabric is knitted in the form of a multilayer knitted fabric including a front structure 201 and a back structure 202 including insulating yarns 300 as a base, the front and back structures 201 and 202 being linked together by linking yarns 100, the conductive yarns 400 are knitted in at least one of the front and back structures 201 and 202, and the ratio (D1/D2) of a diameter (D1) of the conductive yarn 400 and a diameter (D2) of the insulating yarn is 0.81 to 4.0.

### TECHNICAL FIELD

The present invention relates to planar heat-generating knitted fabrics having a knitted fabric including conductive yarns as a heat-generating portion, and planar heat-generating bodies using the planar heat-generating knitted fabrics.

### BACKGROUND ART

Planar heat-generating bodies are widely used in, for example, interior design articles for vehicles, clothes, health, nursing care, and medical products, furniture, and the like.

A conventional type of planar heat-generating body includes a support layer and a metal layer, which are put on top of each other (see, for example, Patent Document 1). Patent Document 1 describes a planar heat-generating body in which a film of copper is formed on a surface of a polyester nonwoven fabric by sputtering, and electrodes are attached to the copper film.

Another conventional type of planar heat-generating body is a knitted fabric that employs conductive yarns and elastic yarns in combination (see, for example, Patent Document 2). Patent Document 2 describes a planar heat-generating body that employs silver-plated fibers as the conductive yarn, and a polyurethane yarn as the elastic yarn, and that has a knit structure in which loops of the conductive yarn arranged in the course direction appear on the front and back sides during knitting.

### CITATION LIST

### Patent Literature

Patent Document 1: International Publication WO2016/024610
Patent Document 2: Japanese Unexamined Patent Application Publication No. 2017-25417

### SUMMARY OF INVENTION

### Technical Problem

In order to quickly and efficiently heat an object to be heated using a planar heat-generating body, it is necessary to tightly attach the planar heat-generating body to the object to be heated. In this regard, in the planar heat-generating body described in Patent Document 1, the polyester nonwoven fabric is inherently less stretchable, and moreover, a film of copper is formed on a surface of the polyester nonwoven fabric, resulting in an increase in the stiffness of the planar heat-generating body. Therefore, the planar heat-generating body described in Patent Document 1 cannot be said to have good surface followability to an object to be heated.

There is also a demand for a planar heat-generating body that is resistant to heat degradation in terms of durability. In this regard, the planar heat-generating body described in Patent Document 2 employs, as a component, a polyurethane yarn, which is less resistant to heat, and therefore, is not suitable for use over a long period of time or use at high temperature.

Incidentally, in the case of a planar heat-generating body that employs a metal wire as the conductive yarn, when the planar heat-generating body is repeatedly bent, the metal wire may break, or the conductive yarn may stick out from the bent portion of the planar heat-generating body. Therefore, there is a demand for a planar heat-generating body in which a metal wire employed as the conductive yarn does not break or stick out when bent (surface quality).

Furthermore, for a planar heat-generating body that employs a metal wire as the conductive yarn, there is a demand for properties such as quick heat generation (quick heating performance), less wearing (wear resistance), and prevention of break and irreversible bending of the conductive yarn during knitting (knittability).

With the above problems in mind, the present invention has been made. It is an object of the present invention to provide a planar heat-generating knitted fabric and planar heat-generating body that employ a metal wire as a conductive yarn, but have good surface followability to an object to be heated, and excellent durability, quick heating performance, and the like.

### Solution to Problem

A characteristic feature of a planar heat-generating knitted fabric according to the present invention that addresses the above problems is a planar heat-generating knitted fabric comprising:

a knitted fabric including conductive yarns as a heat-generating portion,

wherein
the conductive yarn has a core yarn, and a conductive sheath yarn wrapped around the core yarn,
the conductive sheath yarn is a metal wire covered with an insulating resin,
the knitted fabric is knitted in the form of a multilayer knitted fabric including a front and a back structure including insulating yarns as a base, the front and back structures being linked together by linking yarns,
the conductive yarns are knitted in at least one of the front and back structures, and
the ratio (D1/D2) of a diameter (D1) of the conductive yarn and a diameter (D2) of the insulating yarn is 0.81 to 4.0.

In the planar heat-generating knitted fabric thus configured, the knitted fabric including the conductive yarns serves as a heat-generating portion, and the knitted fabric is knitted in the form of a multilayer knitted fabric using the linking yarns linking the front and back structures together. Therefore, due to the stretchability of the knitted fabric, the heat-generating portion can be deformed, highly following the shape of an object to be heated, and therefore, excellent surface followability is achieved. In addition, since the knitted fabric is a multilayer knitted fabric, the stretchability thereof can be satisfactorily improved without using elastic yarns such as urethane yarns, which are conventionally used and are susceptible to heat. Therefore, a planar heat-generating knitted fabric that is less likely to be degraded due to heat, i.e., has excellent durability, can be provided. In addition, the ratio (D1/D2) of the diameter (D1) of the conductive yarn and the diameter (D2) of the insulating yarn is 0.81 to 4.0, and therefore, an object to be heated can be heated quickly and efficiently, and therefore, excellent quick heating performance is achieved. In addition, the conductive yarns are knitted in at least one of the front and back structures, and therefore, the conductive yarns are arranged generally in parallel with that structure, which, together with the above feature (the ratio (D1/D2) is in the above range), prevents the conductive yarns from sticking out when the planar heat-generating knitted fabric is bent, and therefore, excellent surface quality and wear resistance are achieved. Furthermore, since the ratio (D1/D2) is in the above range, the conductive yarns can be prevented from breaking and irreversibly bending during knitting, and therefore, excellent knittability is achieved.

In the planar heat-generating knitted fabric according to the present invention,
in the conductive yarn, the conductive sheath yarn is preferably wrapped around the core yarn with 100 to 1000 turns per meter of the core yarn.

In the planar heat-generating knitted fabric thus configured, a conductive yarn in which a conductive sheath yarn is wrapped around a core yarn with 100 to 1000 turns per meter of the core yarn is used, resulting in a further improvement in the stretchability of the knitted fabric. Therefore, a planar heat-generating knitted fabric having excellent surface followability, bending durability, surface quality, wear resistance, and knittability can be provided.

In the planar heat-generating knitted fabric according to the present invention,
the conductive yarns are preferably spaced apart from each other in the course or wale direction of the knitted fabric, and
the ratio (a:b) of the number (a) of the conductive yarns and the number (b) of the insulating yarns is preferably 1:9 to 1:1.

In the planar heat-generating knitted fabric thus configured, the conductive yarns are spaced apart from each other in the course or wale direction of the knitted fabric. Therefore, a force that acts on the conductive yarns when the planar heat-generating knitted fabric is bent can be reduced by the insulating yarns. As a result, a great load can be prevented from being applied to the conductive yarns, resulting in an improvement in the bending durability of the planar heat-generating knitted fabric. In addition, since the conductive yarns are spaced apart from each other, the quick heating performance of the planar heat-generating knitted fabric can be adjusted. In addition, the ratio (a:b) of the number (a) of the conductive yarns and the number (b) of the insulating yarns is 1:9 to 1:1, resulting in an improvement in the quick heating performance of the entire planar heat-generating knitted fabric. In addition, since the ratio (a/b) is in the above range, the stretchability of the knitted fabric is further improved. Therefore, a planar heat-generating knitted fabric having excellent surface followability, bending durability, surface quality, wear resistance, and knittability can be provided.

In the planar heat-generating knitted fabric according to the present invention,
the core yarn preferably has a fineness of at most 56 dtex.

The planar heat-generating knitted fabric thus configured uses a core yarn having a fineness of at most 56 dtex. Therefore, the flexibility of the planar heat-generating knitted fabric is further improved. Therefore, a planar heat-generating knitted fabric having excellent surface followability, bending durability, surface quality, wear resistance, and knittability can be provided.

In the planar heat-generating knitted fabric according to the present invention,
the conductive sheath yarn preferably has an electrical resistivity of at most 5×10⁻⁵ Ω·m.

The planar heat-generating knitted fabric thus configured uses a conductive sheath yarn having an electrical resistivity of at most 5×10⁻⁵ Ω·m. Therefore, the temperature increase rate of the heat-generating portion is increased. Therefore, a planar heat-generating knitted fabric having excellent quick heating performance can be provided.

In the planar heat-generating knitted fabric according to the present invention, the knitted fabric preferably contains at least 5 wt % of the conductive sheath yarns.

In the planar heat-generating knitted fabric thus configured, the knitted fabric contains at least 5 wt % of the conductive sheath yarns. Therefore, the amount of heat generated per unit area in the heat-generating portion can be increased. Therefore, a planar heat-generating knitted fabric having excellent heat retention performance after heating in addition to quick heating performance can be provided.

In the planar heat-generating knitted fabric according to the present invention,
the front and back structures preferably have the same type of structure.

In the planar heat-generating knitted fabric thus configured, the front and back structures have the same type of structure. Therefore, a planar heat-generating knitted fabric having more excellent bending durability can be provided.

A characteristic feature of a planar heat-generating body according to the present invention that addresses the above problems is a planar heat-generating body comprising:
the planar heat-generating knitted fabrics according to any one of the above aspects; and
an electrode provided on the knitted fabric, wherein
in a region of the planar heat-generating knitted fabric where the electrode is provided, the metal wire of the conductive sheath yarn is exposed by treatment of the conductive sheath yarn.

The planar heat-generating body thus configured uses the planar heat-generating knitted fabric according to the present invention. Therefore, a planar heat-generating body can be provided that has good surface followability to an object to be heated, is less likely to be degraded due to heat, i.e., has excellent durability, s excellent bending durability against repeated bending, quick heating performance, i.e., quick heat generation, surface quality that prevents the conductive yarns from sticking out from the surface when the body is bent, less wearing, i.e., wear resistance, and knittability that prevents the conductive yarns from breaking and irreversibly bending during knitting. Here, in the planar heat-generating body, in a region of the planar heat-generating knitted fabric where the electrode is provided, the metal wire of the conductive sheath yarn is exposed by treatment of the conductive sheath yarn. Therefore, while electric current conduction between the electrode and the conductive sheath yarns is ensured, a short circuit between adjacent conductive yarns can be prevented by the insulating resin, resulting in both of excellent quick heating performance and high safety.

### BRIEF DESCRIPTION OF DRAWINGS

FIG. 1 is a perspective view of a planar heat-generating body according to the present invention.

FIG. 2 is a perspective view schematically illustrating the structure of a planar heat-generating knitted fabric according to the present invention.

FIG. 3 is an explanatory diagram illustrating a detailed configuration of a conductive yarn.

FIG. 4 is an explanatory diagram illustrating a diameter of a conductive yarn.

FIG. 5 is an explanatory diagram illustrating a diameter of an insulating yarn.

### DESCRIPTION OF EMBODIMENTS

A planar heat-generating knitted fabric and planar heat-generating body according to the present invention will be described with reference to the accompanying drawings. It should be noted that in each figure, a configuration (knit structure) is exaggerated or simplified, as appropriate, for the sake of convenience, and yarns included in knit structures are not exactly identical to those in actual planar heat-generating knitted fabrics and planar heat-generating bodies in terms of size and scale relationships.

### Planar Heat-Generating Body

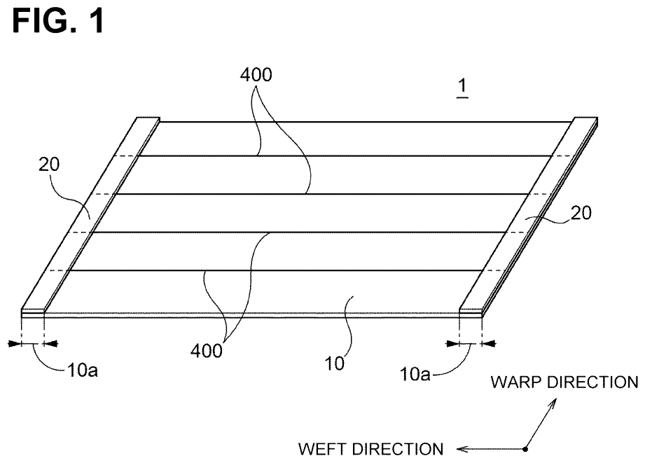

FIG. 1 is a perspective view of a planar heat-generating body 1 according to the present invention. In the planar heat-generating body 1, an electrode 20 is provided in each of two installation regions 10a, which are spaced apart in the course direction (weft direction), in a planar heat-generating knitted fabric 10 according to the present invention described below. Conductive yarns 400 are knitted in the planar heat-generating knitted fabric 10, extending in the course direction (weft direction). The planar heat-generating knitted fabric 10, which is stretchable, can be deformed, highly following the shape of an object to be heated. As described below, the conductive yarn 400 contains a metal wire covered with an insulating resin. In the installation region 10a, the insulating resin is removed from the conductive yarn 400 by a laser removal process or the like so that the metal wire is exposed. Each electrode 20 is electrically connected to a plurality of conductive yarns 400 arranged in parallel in the wale direction (warp direction) in the respective installation region 10a. When a voltage is applied between the two electrodes 20, the planar heat-generating body 1 generates heat by Joule heating using the conductive yarns 400, which are conductive between the electrodes, thereby heating or keeping an object to be heated warm. It should be noted that representative examples of an object to be heated include interior design articles for vehicles such as steering wheels and seats. The planar heat-generating body 1 is used and arranged to cover the surface of an object to be heated.

### Planar Heat-Generating Knitted Fabric

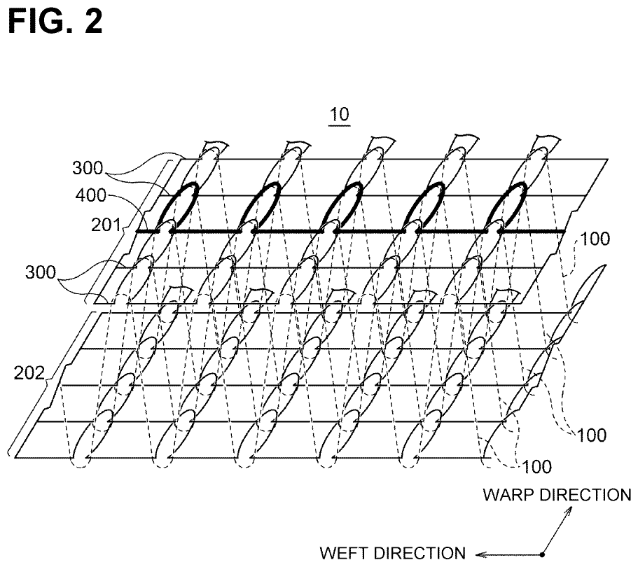

FIG. 2 is a perspective view schematically illustrating the structure of the planar heat-generating knitted fabric 10 according to the present invention. The planar heat-generating knitted fabric 10 is a multilayer knitted fabric that includes a front structure 201 and a back structure 202, which are linked together using linking yarns 100. The planar heat-generating knitted fabric 10, which is a multilayer knitted fabric, is sufficiently stretchable even without the use of elastic yarns such as urethane yarns, which are conventionally used and are susceptible to heat. Furthermore, since elastic yarns such as urethane yarns, which are susceptible to heat, are not used, the planar heat-generating knitted fabric 10 is less likely to be degraded due to heat and therefore is durable. The planar heat-generating knitted fabric 10 may be a multilayer knitted fabric having at least three layers including another knitted fabric between the front structure 201 and the back structure 202. However, a double knitted fabric is preferable because such a knitted fabric is flexible enough to follow the shape of the surface of an object to be heated.

The conductive yarns 400 are knitted in at least one of the front structure 201 and the back structure 202, which include insulating yarns 300 as the base. Specifically, in at least one of the front structure 201 and the back structure 202, the conductive yarns 400 are used in combination with the insulating yarns 300, and are knitted together with the insulating yarns 300. Furthermore, the conductive yarns 400 and the insulating yarns 300 separately form respective loops. The conductive yarns 400 and the insulating yarns 300 are knitted together such that the loops thereof are hooked with each other. In other words, a portion of the insulating yarns 300 are replaced with the conductive yarns 400 in the fabric. Thus, the conductive yarns 400 are knitted generally in parallel with at least one of the front structure 201 and the back structure 202. Since the conductive yarns 400 are knitted in such a manner, the conductive yarns 400 can be prevented from irreversibly bending, resulting in prevention of abnormal heat generation and break of the conductive yarn 400, which improves reliability and contributes to an improvement in quality. In the embodiment illustrated in FIG. 2, the conductive yarns 400 are knitted in the front structure 201. Alternatively, the conductive yarns 400 may be knitted in the back structure 202 or in both of the front structure 201 and the back structure 202.

The conductive yarns 400 are preferably arranged in at least one of the front structure 201 and the back structure 202 so as to be spaced apart from each other (not in contact with each other) in the course or wale direction. Such an arrangement in which the conductive yarns 400 are spaced apart from each other can be obtained by using the conductive yarns 400 and the insulating yarns 300 in n combination. If the conductive yarns 400 and the insulating yarns 300 are used in combination such that the conductive yarns 400 are spaced apart from each other, a force that acts on the conductive yarns 400 when the planar heat-generating knitted fabric 10 is bent can be reduced by the insulating yarns 300, and therefore, a great load can be prevented from being applied to the conductive yarns 400. As a result, the bending durability of the planar heat-generating knitted fabric 10 can be improved. The arrangement in which the conductive yarns 400 are spaced apart from each other also allows adjustment of the quick heating performance of the planar heat-generating knitted fabric 10. Here, the ratio (a:b) of the number (a) of the conductive yarns 400 and the number (b) of the insulating yarns 300 in at least one of the front structure 201 and the back structure 202 (hereinafter also referred to as a “mixture ratio”) is preferably 1:9 to 1:1, more preferably 1:5 to 1:1. If the mixture ratio is in these ranges, the quick heating performance of the entire planar heat-generating knitted fabric can be improved. In addition, if the ratio (a/b) in these ranges, the stretchability of the planar heat-generating knitted fabric 10 is further improved, so that the planar heat-generating knitted fabric 10 can have excellent surface followability, bending durability, surface quality, wear resistance, and knittability.

### Front Structure and Back Structure

The front structure 201 and the back structure 202, which include the insulating yarns 300 as the base, are preferably a weft-knitted fabric having a weft-knit structure such as stockinette stitch, ribbing stitch, or purl stitch. In addition, the front structure 201 and the back structure 202 preferably have the same knit structure. If the front structure 201 and the back structure 202 have the same knit structure, the front structure 201 and the back structure 202 have similar flexibility. In this case, when the planar heat-generating knitted fabric 10 is bent, a load is uniformly applied to the conductive yarns 400 knitted in at least one of the front structure 201 and the back structure 202, resulting in preferable bending durability of the planar heat-generating knitted fabric 10.

### Insulating Yarn

The insulating yarn 300, which is the base for the front structure 201 and the back structure 202, is in the form of, for example, spun yarn (short fiber yarn), multifilament yarn, monofilament yarn, or the like. Multifilament yarn may be optionally twisted, or may be subjected to a treatment such as false twisting or fluid agitation. The fineness (total fineness) of the insulating yarn 300 is preferably at most 330 dtex, more preferably at most 167 dtex, and even more preferably at most 84 dtex. The fineness (total fineness) of the insulating yarn 300 is preferably at least 56 dtex. If the total fineness of the yarn used as the base yarn of the front structure 201 and the back structure 202 is at most 330 dtex, the base structure of the front structure 201 and the back structure 202 is flexible, and therefore, the planar heat-generating knitted fabric 10 has excellent surface followability. If the fineness (total fineness) of the insulating yarn 300 is at least 56 dtex, the planar heat-generating knitted fabric 10 has excellent bending durability. The insulating yarn 300 preferably has a diameter (D2) of at most 175 μm, more preferably at most 125 μm, and even more preferably at most 88 μm. The diameter (D2) of the insulating yarn 300 is preferably at least 72 μm. If the diameter (D2) of the insulating yarn 300 used as the base yarn of the front structure 201 and the back structure 202 is at most 175 μm, the base structure of the front structure 201 and the back structure 202 is flexible, and therefore, the planar heat-generating knitted fabric 10 has excellent surface followability. If the diameter (D2) of the insulating yarn 300 is at least 72 μm, the planar heat-generating knitted fabric 10 has excellent bending durability. It should be noted that the diameter (D2) of the insulating yarn 300 is described below.

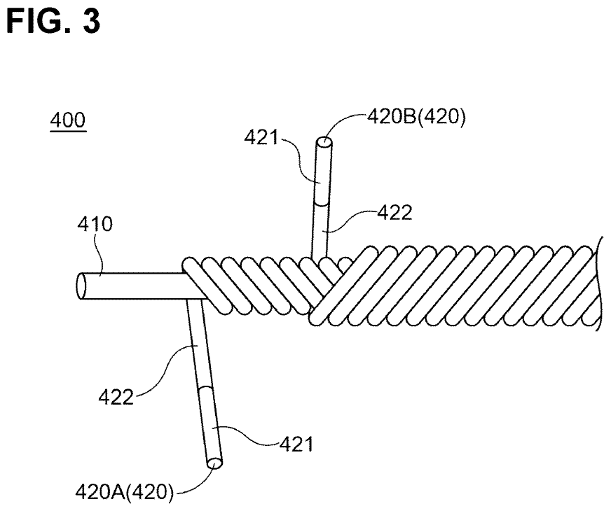

A material for the fibers constituting the insulating yarn 300 is not particularly limited. Examples of such a material include natural fibers, regenerated fibers, semisynthetic fibers, and synthetic fibers. These may be used alone or in combination. Of them, synthetic fibers are preferable because of the excellent strength thereof. Polyester fibers, such as polyethylene terephthalate, are preferable, and cationic dyeable polyester fiber (CDP) is more preferable. If the insulating yarn 300 is made of synthetic fibers, a core yarn 410 and an insulating resin 422 (described below) of a conductive sheath yarn 420 can be melted by a laser removal process or the like in the front structure 201 and the back structure 202, and therefore, only a coiled metal wire 421 can be clearly exposed in the installation region 10a (see FIG. 3). The shape of the fiber is not particularly limited. The fiber may be either a long fiber or a short fiber. In addition, the cross-sectional shape of the fiber is not particularly limited, and may be typically circular, or alternatively, different shapes, such as flat, elliptical, triangular, hollow, Y-shaped, T-shaped, and U-shaped.

### Conductive Yarn

FIG. 3 is a diagram for describing a detailed structure of the conductive yarn 400. The conductive yarn 400 is a covering yarn having a core yarn 410, and a conductive sheath yarn 420 wrapped around the core yarn 410. The conductive sheath yarn 420 is obtained by coating a metal wire 421 with an insulating resin 422. The conductive yarn 400, which is the covering yarn having the core yarn 410 and the conductive sheath yarn 420, is stretchable. The conductive yarn 400 may be either a single-covering yarn in which a single conductive sheath yarn 420 is wrapped around the core yarn 410, or a double-covering yarn in which two conductive sheath yarns 420 are wrapped around the core yarn 410. The conductive yarn 400 is preferably a double-covering yarn. FIG. 3 illustrates a double-covering yarn in which two conductive sheath yarns 420A and 420B are wrapped around a core yarn 410. If the conductive yarn 400 is such a double-covering yarn, the temperature increase rate of the planar heat-generating knitted fabric 10 increases, resulting in excellent quick heating performance.

The core yarn 410 used in the conductive yarn 400 is preferably a monofilament yarn or a multifilament yarn. The fineness of the core yarn 410 is preferably 22-56 dtex. If the fineness of the core yarn 410 is at most 56 dtex, the conductive yarn 400 is flexible, resulting in an improvement in the flexibility of the planar heat-generating knitted fabric 10. Therefore, the planar heat-generating knitted fabric 10 can have excellent surface followability, bending durability, surface quality, wear resistance, and knittability. If the fineness of the core yarn 410 is at least 22 dtex, the bending durability of the planar heat-generating knitted fabric 10 can be improved. The core yarn 410 preferably has a diameter of 45 to 72 μm. If the diameter of the core yarn 410 is at most 72 μm, the conductive yarn 400 is flexible, resulting in an improvement in the flexibility of the planar heat-generating knitted fabric 10, and therefore, the planar heat-generating knitted fabric 10 can have excellent surface followability, bending durability, surface quality, wear resistance, and knittability. If the diameter of the core yarn 410 is at least 45 μm, the bending durability of the planar heat-generating knitted fabric 10 can be improved. As used herein, the diameter of the core yarn 410 means a greatest diameter.

The core yarn 410 is made of a material (heat-meltable material) that can be easily removed by, for example, a laser removal process in order to form the installation region 10a where the electrode 20 is to be attached to the planar heat-generating knitted fabric 10. Such a material for the core yarn 410 is preferably a synthetic fiber in terms of strength. Examples of such a synthetic fiber include polyester fibers. In particular, polyethylene terephthalate is preferable. If the core yarn 410 is made of such a material, the core yarn 410 is melted together with the insulating resin 422 of the conductive sheath yarn 420 when the conductive yarn 400 is heated by a laser removal process. As a result, in the installation region 10a where the electrode 20 is to be attached to the planar heat-generating knitted fabric 10, the coil-shaped metal wire 421 remains after the removal of the core yarn 410 and the insulating resin 422 from the conductive yarn 400, and is therefore exposed in the surface of the installation region 10a.

The conductive sheath yarn 420 has the metal wire 421, and the insulating resin 422 covering the metal wire 421. The metal wire 421 preferably has a diameter of 20 to 80 μm, more preferably 25 to 70 μm. If the diameter of the metal wire 421 is in these ranges, the planar heat-generating knitted fabric 10 has excellent bending durability and surface followability. In particular, if the diameter of the metal wire 421 is at least 20 μm, the metal wire 421 is less likely to break when the planar heat-generating knitted fabric 10 is bent, resulting in an improvement in bending durability and knittability. If the diameter of the metal wire 421 is at most 80 μm, the conductive yarn 400 is not too hard, resulting in an improvement in the surface followability and knittability of the planar heat-generating knitted fabric 10. As used herein, the diameter of the metal wire 421 means a greatest diameter.

Examples of a material for the metal wire 421 include single metals such as aluminum, nickel, copper, titanium, magnesium, tin, zinc, iron, silver, gold, platinum, vanadium, molybdenum, tungsten, chromium, manganese, silicon, lead, bismuth, boron, germanium, arsenic, antimony, tellurium, and cobalt, and alloys thereof. Of them, copper and nickel, alloys of copper and silicon, and an alloy called nichrome are preferable in terms of suitable resistance value and cost. It should be noted that the conductive sheath yarn 420 can employ carbon fibers instead of the metal wire 421 covered with the insulating resin 422.

The insulating resin 422 protects the metal wire 421, ensures insulating properties, and prevents the metal wire 421 from breaking due to bending or the like. The insulating resin 422 is a material (heat-meltable material) that can be easily removed by a laser removal process or the like in order to provide electrical conduction between the metal wire 421 and the electrode 20 in the installation region 10a of the planar heat-generating knitted fabric 10. Such a material for the insulating resin 422 is preferably a synthetic resin, and is more preferably a thermoplastic elastomer (TPE), even more preferably an ester imide or a polyurethane in terms of bending resistance, oil resistance, wear resistance, and toughness. It should be noted that polyurethanes include thermosetting polyurethanes and thermoplastic polyurethanes, and thermosetting polyurethanes may be used. The thickness of the insulating resin 422 is preferably 4 to 8 μm. If the thickness of the insulating resin 422 is in this range, the conductive sheath yarn 420 has preferable bending durability and flexibility. In particular, if the thickness of the insulating resin 422 is at least 4 μm, the metal wire 421 is sufficiently protected. If the thickness of the insulating resin 422 is at most 8 μm, the conductive sheath yarn 420 can be inhibited from being too hard, and therefore, the surface followability of the planar heat-generating knitted fabric 10 is improved, and the insulating resin 422 can be easily thoroughly removed by a laser removal process or the like.

The electrical resistivity of the conductive sheath yarn 420 is preferably at most 5×10⁻⁵ Ω·m, more preferably at most 1.5×10⁻⁶ Ω·m, and even more preferably at most 5.0×10⁻⁷ Ω·m. If the electrical resistivity of the conductive sheath yarn 420 is at most 5×10⁻⁵ Ω·m, excellent quick heating performance can be imparted to a planar heat-generating knitted fabric 10 having a size of about 40 cm in the weft direction that is used as an interior design article for vehicles such as a steering wheel heater or a seat heater, because the planar heat-generating knitted fabric 10 has a higher temperature increase rate due to appropriate heat generated by Joule heating when a voltage of 13 V is applied thereto by an in-vehicle battery.

The number of turns of the conductive sheath yarn 420 per meter of the core yarn 410 (hereinafter simply referred to as “the number of turns”) is preferably 100 to 1000, more preferably 200 to 500. If the number of turns of the conductive sheath yarn 420 is in these ranges, the conductive yarn 400 is flexible, resulting in a further improvement in the stretchability of the planar heat-generating knitted fabric 10, and therefore, the planar heat-generating knitted fabric 10 can have excellent surface followability, bending durability, surface quality, wear resistance, and knittability. In particular, if the number of turns of the core yarn 410 is at least 100, the planar heat-generating knitted fabric 10 contains a sufficient amount of the conductive sheath yarns 420, resulting in an increase in the amount of heat generated per unit area, i.e., sufficient quick heating performance. If the number of turns of the core yarn 410 is at most 1000, the conductive yarn 400 can be inhibited from being too hard, resulting in an improvement in the surface followability and the like of the planar heat-generating knitted fabric 10.

The contained amount of the conductive sheath yarns 420 is preferably at least 5 wt %, more preferably at least 10 wt %, and even more preferably at least 15 wt % with respect to the weight of the planar heat-generating knitted fabric 10 (the ratio of the weight of the conductive sheath yarns 420 to the weight of the planar heat-generating knitted fabric 10 is hereinafter also referred to as a “metal wire ratio”). If the metal wire ratio is at least 5 wt %, the planar heat-generating knitted fabric 10 generates a greater amount of heat per unit area, and therefore, has excellent heat retention performance after heating in addition to quick heating performance.

Ratio (D1/D2) of diameter (D1) of conductive yarn and diameter (D2) of insulating yarn

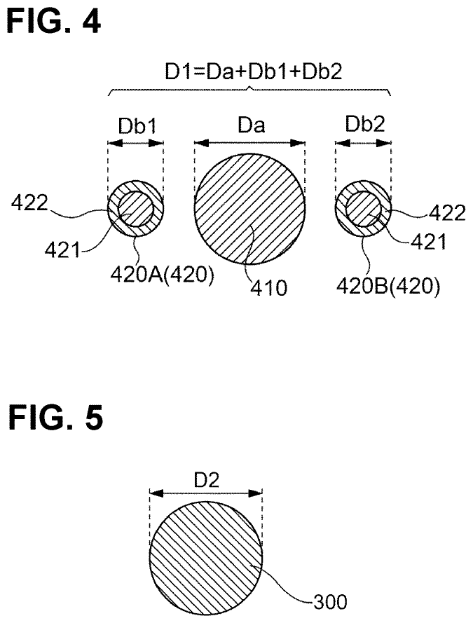

Here, in the conductive yarn 400, the tightness of attachment of the core yarn 410 and the conductive sheath yarn 420 varies depending on the form in which the conductive sheath yarn 420 is put on top of the core yarn 410. As a result, the diameter of the conductive yarn 400 including the core yarn 410 and the conductive sheath yarn 420 may vary. As illustrated in FIG. 4, the diameter (D1) of the conductive yarn 400 is herein defined as the sum of the diameter (Da) of the core yarn 410 and the diameter (Db) of the conductive sheath yarn 420 (D1=Da+Db). In other words, the diameter (D1) of the conductive yarn 400 is defined as a greatest diameter that can be taken when the conductive sheath yarn 420 is put on top of the core yarn 410. In this embodiment, two conductive sheath yarns 420 are wrapped around the core yarn 410. Therefore, the diameter (D1) of the conductive yarn 400 is the sum of the diameter (Da) of the core yarn 410, the diameter (Db1) of a conductive sheath yarn 420A that is one (here, the inner one) of the two conductive sheath yarns 420, and the diameter (Db2) of a conductive sheath yarn 420B that is the other (here, the outer one) (D1=Da+Db1+Db2). The diameter (Da) of the core yarn 410 and the diameter (Db) of the conductive sheath yarn 420 are each a greatest diameter. The diameter (Db) of the conductive sheath yarn 420 is the sum of the diameter of the metal wire 421 and the thickness (×2) of the insulating resin 422.

Incidentally, in the case in which the conductive yarn 400 is the double-covering yarn in which the conductive sheath yarn 420A is wrapped around the core yarn 410, and the conductive sheath yarn 420B is wrapped around the conductive sheath yarn 420A, the actual measurement value of the diameter D1 of the conductive yarn 400 may happen to be D1=Da+2Db1+2Db2 at a maximum, depending on how the conductive sheath yarns 420A and 420B are wrapped around the core yarn 410. However, in the present invention, in order to objectively assess the quick heating performance, surface quality, wear resistance, and knittability of the planar heat-generating knitted fabric 10, the diameter D1 of the conductive yarn 400 is considered to be the sum (D1=Da+Db1+Db2) of the diameters of the yarns constituting the conductive yarn 400 instead of the actual measurement value that may vary depending on how yarns are wrapped around a core. Therefore, for example, in the case in which a single-covering yarn obtained by wrapping only the conductive sheath yarn 420A around the core yarn 410 is used as the conductive yarn 400 (the conductive sheath yarn 420B is removed from the conductive yarn 400 that is the double-covering yarn illustrated in FIG. 3), the diameter (D1) of the conductive yarn 400 is the sum of the diameter (Da) of the core yarn 410 and the diameter (Db1) of the conductive sheath yarn 420A (D1=Da+Db1).

As illustrated in FIG. 5, the diameter (D2) of the insulating yarn 300 is a greatest diameter of the insulating yarn 300.

Here, properties of at least one of the front structure 201 and the back structure 202 (i.e., a cloth including the conductive yarns 400 as a part thereof) are determined by the ratio (D1/D2) of the diameter (D1) of the conductive yarn 400 and the diameter (D2) of the insulating yarn 300. As the ratio (D1/D2) decreases, i.e., the diameter (D1) of the conductive yarn 400 decreases relative to the diameter (D2) of the insulating yarn 300, stiffness attributed to the conductive yarn 400, which is relatively hard, decreases, so that the planar heat-generating knitted fabric 10 is more easily bent, resulting in an improvement in flexibility, while the conductive yarn 400 is more likely to break when bent. The quick heating performance is also likely to decrease. Furthermore, the conductive yarn 400 is likely to break during knitting. As the ratio (D1/D2) increases, i.e., the diameter (D1) of the conductive yarn 400 increases relative to the diameter (D2) of the insulating yarn 300, the stiffness of the conductive yarn 400 relatively increases, so that the planar heat-generating knitted fabric 10 is less easily bent, and therefore, the bending durability and wear resistance of the planar heat-generating knitted fabric 10 are likely to decrease. In addition, a loop of the conductive yarn 400 is likely to stick out from the cloth, resulting in a decrease in surface quality. Furthermore, the conductive yarn 400 is likely to be too thick, so that the conductive yarn 400 is likely to irreversibly bend during knitting. The ratio (D1/D2) of the diameter (D1) of the conductive yarn 400 and the diameter (D2) of the insulating yarn 300 is 0.81 to 4.0, more preferably 0.9 to 4.0, and even more preferably 1.0 to 3.6. If the ratio (D1/D2) is 0.81 to 4.0, an object to be heated can be heated quickly and efficiently, resulting in excellent quick heating performance. In addition, the conductive yarn 400 is prevented from sticking out when the planar heat-generating knitted fabric 10 is bent, resulting in excellent surface quality and wear resistance. Furthermore, if the ratio is in the above range, the conductive yarn is prevented from breaking and irreversibly bending during knitting, resulting in excellent knittability.

### Linking Yarn

The linking yarn 100 is knitted in loops of a single base yarn of the front structure 201 and loops of a single base yarn of the back structure 202 alternately in the weft direction, in which the loops are continuously arranged. As illustrated in FIG. 2, in the planar heat-generating knitted fabric 10, the front structure 201 and the back structure 202 are linked together. As the linking yarn 100, the same type of insulating yarn as that of the insulating yarn 300 can be used.

### Characteristics of Planar Heat-Generating Knitted Fabric

The planar heat-generating knitted fabric 10 preferably has a constant load elongation ratio of at least 10%, more preferably at least 20%. If the constant load elongation ratio of the planar heat-generating knitted fabric 10 is at least 10%, the stretchability and followability of the planar heat-generating knitted fabric 10 are improved. The constant load elongation ratio (%) of the planar heat-generating knitted fabric 10 can be determined with reference to D-method (cut strip method) for the “elongation ratio” in JIS-L1096 8.16.1. Specifically, a sample (specimen, width: 2.5 cm) is obtained from the planar heat-generating knitted fabric 10 in each of the warp and weft directions. A constant speed elongation type tensile tester with a self-recording device (Autograph AG-I/20 kN-50 kN, manufactured by Shimadzu Corporation) is used. A load applied to a sample is increased under conditions that the distance between the grips (chucks) upon the start is 10 cm and the constant elongation rate is 20 cm/min. The elongation ratio (%) in the warp or weft direction in the presence of an applied load of 5 N is determined as the constant load elongation ratio (%) of the planar heat-generating knitted fabric 10.

The stiffness of the planar heat-generating knitted fabric 10 as measured in accordance with JIS L1096 8.21 (A-method (45° cantilever method)) is preferably at most 50 mm lengthwise and at most 50 mm crosswise. If the stiffness of the planar heat-generating knitted fabric 10 is at most 50 mm lengthwise and at most 50 mm crosswise, the followability of the planar heat-generating knitted fabric 10 is improved.

### Electrode

The electrode 20 is, for example, provided in the form of a conductive film obtained by vapor deposition of a metal on a surface of a resin film such as a polyimide film, or a film to which a metal foil is attached. The electrode 20 is attached to each of the two installation regions 10a, which are spaced apart from each other in the weft direction, in the planar heat-generating knitted fabric 10. In the installation region 10a, the insulating resin 422 in the surface of the conductive sheath yarn 420 wrapped around the core yarn 410 of the conductive yarn 400 is removed together with the core yarn 410 by a laser removal process or the like, so that the coiled metal wire 421 is exposed. Therefore, in the installation region 10a, the electrode 20 is electrically connected to the conductive yarns 400. Examples of the metal that is vapor-deposited on the resin film include single metals such as aluminum, nickel, copper, titanium, magnesium, tin, zinc, iron, silver, gold, platinum, vanadium, molybdenum, tungsten, chromium, manganese, silicon, lead, bismuth, boron, germanium, arsenic, antimony, tellurium, and cobalt, and alloys thereof. Of them, copper and tin are preferable.

### Characteristics of Planar Heat-Generating Body

The planar heat-generating body 1 according to the present invention preferably has, as an indication of quick heating performance, quick heating performance such that when an electric current is conducted therethrough with the surface temperature kept at 25° C., the time it takes for the surface temperature to reach 65° C. is at most 90 seconds, more preferably at most 70 seconds. If the planar heat-generating body 1 has such quick heating performance, the planar heat-generating body 1 can be particularly suitably used in interior design articles for vehicles such as steering wheel heaters and seat heaters.

### EXAMPLES

Planar heat-generating knitted fabrics (Examples 1 to 33) having characteristic features of the present invention were produced, and measured and assessed in terms of various items. In addition, for comparison, planar heat-generating knitted fabrics (Comparative Examples 1 to 5) that do not have any characteristic feature of the present invention were produced, and measured and assessed in a similar manner. Measurement and assessment items were surface quality, quick heating performance, stiffness, surface followability, bending durability, wear resistance, and knittability. The items are described below.

### Surface Quality

As an indication of surface quality, a planar heat-generating knitted fabric was visually inspected to determine whether a conductive yarn stuck out from the planar heat-generating knitted fabric when the planar heat-generating knitted fabric was bent. The following criteria were used for the assessment.
+: sticking out of any conductive yarn was not observed
−: sticking out of a conductive yarn was observed

### Quick Heating Performance

Quick heating performance was measured through the following procedure. A specimen of 3.8 cm in the warp direction and 11.5 cm in the weft direction was taken from a planar heat-generating knitted fabric. A 2-cm region at either end of the specimen in the weft direction was subjected to a laser removal process to remove the core yarn and the insulating resin, so that an installation region where the metal wire was exposed was formed. A conductive film electrode of 5 cm×2 cm was attached to each installation region. Thus, a planar heat-generating body was prepared. The specimen was covered with a synthetic leather (trade name: Leather-bee B-1000, manufactured by Masuda Co. Ltd., thickness: 0.78 mm). The temperature of the surface of the synthetic leather was measured by thermography (manufactured by FLIR, product no.: FLIR C2). The specimen was put in an environment of 25° C. A voltage of 5 V was applied between the electrodes. The time it took for the temperature measured by thermography to reach 65° C. was measured. The following criteria were used for assessment of quick heating performance.
++: less than 70 seconds
+: at least 70 seconds and less than 90 seconds
−: at least 90 seconds

### Stiffness

Stiffness was measured in accordance with A-method (45° cantilever method) in “8.21 Stiffness” of “JIS L 1096 Testing methods for woven and knitted fabrics.” A specimen of 20 mm×150 mm was taken from a planar heat-generating knitted fabric in each of the warp and weft directions. The specimen was mounted on a cantilever tester having a 45°-inclined surface with a short side of the specimen set on the scale reference line, so that the specimen gradually slid in the direction of the inclined surface. When the central point of the end of the specimen was in contact with the inclined surface, the position of the other end was read from the scale. The length (mm) over which the specimen was moved was determined as the stiffness.

### Surface Followability

A planar heat-generating knitted fabric was mounted and fixed along the surface of a trapezoidal box. The presence or absence of a space between the cloth and the box surface, and a crease, was visually inspected. The following criteria were used for assessment of surface followability.
++: there are no cloth space and no crease
+: there is a crease but no cloth space
−: there is a space between the cloth and the box surface

### Bending Durability

A specimen of 25 mm in the warp direction and 200 mm in the weft direction was taken from a planar heat-generating knitted fabric. The specimen was repeatedly folded at the center thereof in the weft direction with both ends thereof in the weft direction coinciding. Each time the specimen had been folded 1000 times, the presence or absence of a break in the metal wire was inspected by an electric current conduction test. The following criteria were used for assessment of bending durability.
+: there is no break even when folding is performed 10000 times
−: there is a break before folding is performed 10000 times

### Wear Resistance

As an indication of wear resistance (tendency of being less likely to break), the wear resistance of a planar heat-generating knitted fabric was tested in accordance with C-method (Taber method) in “8.19 Wear resistance and wear discoloration properties” of “JIS L 1096 Testing methods for woven and knitted fabrics” under conditions that the abrasive wheel No. CS-10 was used, the load was 2.45 N, and the number of times was 500. Thereafter, the surface of the planar heat-generating knitted fabric was visually inspected. The following criteria were used for assessment of wear resistance.
+: no break is observed in the surface
−: a break is observed in the surface

### Knittability

The presence or absence of a break and irreversible bending of a conductive yarn was visually inspected during knitting of a planar heat-generating knitted fabric. The following criteria were used for assessment of knittability.
+: no break and no irreversible bending are observed in any conductive yarn
−: a break or irreversible bending is observed in a conductive yarn

### Example 1

A double-covering, conductive yarn described in Table 1 was prepared using a polyethylene terephthalate yarn of 22 dtex/1f (manufactured by Toray Industries, Inc.) as the core yarn thereof, and a metal wire made of a Cu/Si alloy and having a diameter of 50 μm which is covered with ester imide (thickness: 6 μm) as the conductive sheath yarn thereof, where the number of turns was 300 (turns/m).

A double-sided, stockinette double knit (circular knit) having a course density of 31 (courses/25.4 mm) and a wale density of 33 (wales/25.4 mm) was prepared by a knitting machine of 26 gauges/33 inches (manufactured by Precision Fukuhara Works, Ltd.) using an insulating yarn of 56 dtex/36f and made of a cationic dyeable polyester resin (CDP) as the base yarn of the front structure, the base yarn of the back structure, and the linking yarn. In this preparation, the conductive yarn prepared above was knitted instead of a portion of the insulating yarns of the front structure. In this knitting, the ratio (a:b) of the number (a) of conductive yarns and the number (b) of insulating yarns was set to 1:4. Thus, the planar heat-generating knitted fabric of Example 1 having a configuration described in Table 1 was prepared. In the planar heat-generating knitted fabric of Example 1, the ratio (D1/D2) of the diameter (D1) of the conductive yarn and the diameter (D2) of the insulating yarn was 2.34 as described in Table 1.

### Examples 2 to 23 and Comparative Examples 1 to 4

Planar heat-generating knitted fabrics of Examples 2 to 23 and Comparative Examples 1 to 4 were prepared in a manner similar to that of Example 1, where the fineness (i.e., the diameter) of the core yarn of the conductive yarn, the material and diameter of the metal wire of the conductive sheath yarn, the electrical resistivity of the conductive sheath yarn, the material and fineness (i.e., the diameter) of the insulating yarn, and the ratio (a/b) of the number (a) of conductive yarns and the number (b) of insulating yarns, were set as described in Tables 1 to 5 and 8. The ratios (D1/D2) of the diameter (D1) of the conductive yarn and the diameter (D2) of the insulating yarn of the planar heat-generating knitted fabrics of Examples 2 to 23 and Comparative Examples 1 to 4 are described in Tables 1 to 5 and 8.

### Comparative Example 5

A planar heat-generating knitted fabric of Comparative Example 5 was prepared in a manner similar to that of Example 1, except that a conductive yarn was not used and only insulating yarns were used in the front and back structures of a double-sided, stockinette double knit, and the conductive yarn of Example 1 was used as the linking yarn instead of an insulating yarn. The ratio (D1/D2) of the diameter (D1) of the conductive yarn and the diameter (D2) of the insulating yarn of the planar heat-generating knitted fabric of Comparative Example 5 was described in Table 8.

### Examples 24 to 33

Planar heat-generating knitted fabrics of Examples 24 to 33 were prepared in a manner similar to that of Example 1, where the fineness (i.e., the diameter) of the core yarn in the conductive yarn, the material and diameter of the metal wire in the conductive sheath yarn, the material for the resin in the conductive sheath yarn, the type of the covering of the conductive sheath yarn, the electrical resistivity of the conductive sheath yarn, the material and fineness (i.e., the diameter) of the insulating yarn, and the ratio (a/b) of the number (a) of conductive yarns and the number (b) of insulating yarns, were set as described in Tables 6 and 7. It should be noted that for the planar heat-generating knitted fabrics of Examples 28 to 33, the type of the covering of the conductive sheath yarn was single covering, and the number of turns thereof was 300 (turns/m). The ratios (D1/D2) of the diameter (D1) of the conductive yarn and the diameter (D2) of the insulating yarn of the planar heat-generating knitted fabrics of Examples 24 to 33 are described in Tables 6 and 7.

The configurations, measurement results, and assessment results of the planar heat-generating knitted fabrics of Examples 1 to 33 and Comparative Examples 1 to 5 are described in Tables 1 to 8.

TABLE 1

| | | | Example 1 | Example 2 | Example 3 | Example 4 | Example 5 |
|---|---|---|---|---|---|---|---|
| Conductive | Conductive | Material for metal wire | Cu/Si alloy | Cu/Si alloy | Cu/Si alloy | Cu/Si alloy | Cu/Si alloy |
| yarn | sheath yarn | Diameter of | 50 | 50 | 50 | 50 | 50 |
| | | metal wire (μm) | | | | | |
| | | Material for resin | Ester imide | Ester imide | Ester imide | Ester imide | Ester imide |
| | | Thickness of resin (μm) | 6 | 6 | 6 | 6 | 6 |
| | | Covering | Double | Double | Double | Double | Double |
| | | Electrical resistivity (Ω · m) | 2.47 × 10⁻⁷ | 2.47 × 10⁻⁷ | 2.47 × 10⁻⁷ | 2.47 × 10⁻⁷ | 2.47 × 10⁻⁷ |
| | Core yarn | Material | PET | PET | PET | PET | PET |
| | | Fineness (dtex) | 22 | 22 | 22 | 22 | 22 |
| | | Diameter (μm) | 45 | 45 | 45 | 45 | 45 |

| | | | | | | |
|---|---|---|---|---|---|---|
| | Diameter (D1) (μm) of conductive yarn | 169 | 169 | 169 | 169 | 169 |
| Insulating | Material for insulating yarns of front and back structures | CDP | CDP | CDP | CDP | CDP |
| yarn | Fineness (dtex) of insulating yarn | 56 | 84 | 56 | 84 | 167 |
| | Diameter (D2) (μm) of insulating yarn | 72 | 88 | 72 | 88 | 125 |

| Diameter ratio (D1/D2) | | 2.34 | 1.91 | 2.34 | 1.91 | 1.36 |
|---|---|---|---|---|---|---|
| Where conductive yarns are knitted | | Front | Front | Front | Front | Front |
| | | structure | structure | structure | structure | structure |
| Number-of-yarns ratio (a/b) | | 1:4 | 1:4 | 1:9 | 1:9 | 1:4 |
| Surface quality | | + | + | + | + | + |
| Quick heating performance (sec) | | 44 | 46 | 66 | 68 | 52 |
| | | ++ | ++ | ++ | ++ | ++ |
| Stiffness (mm) | Lengthwise | 38 | 46 | 36 | 44 | 67 |
| | Crosswise | 36 | 45 | 33 | 44 | 63 |

| | | | | | |
|---|---|---|---|---|---|
| Surface followability | ++ | ++ | ++ | ++ | + |
| Bending durability | + | + | + | + | + |
| Wear resistance | + | + | + | + | + |
| Knittability | + | + | + | + | + |

TABLE 2

| | | | Example 6 | Example 7 | Example 8 | Example 9 | Example 10 |
|---|---|---|---|---|---|---|---|
| Conductive | Conductive | Material for metal wire | Cu/Si alloy | Cu/Si alloy | Cu/Si alloy | Cu/Si alloy | Cu/Si alloy |
| yarn | sheath yam | Diameter of | 20 | 20 | 20 | 80 | 80 |
| | | metal wire (μm) | | | | | |
| | | Material for resin | Ester imide | Ester imide | Ester imide | Ester imide | Ester imide |
| | | Thickness of resin (μm) | 6 | 6 | 6 | 6 | 6 |
| | | Covering | Double | Double | Double | Double | Double |
| | | Electrical resistivity (Ω · m) | 2.47 × 10⁻⁷ | 2.47 × 10⁻⁷ | 2.47 × 10⁻⁷ | 2.47 × 10⁻⁷ | 2.47 × 10⁻⁷ |
| | Core yarn | Material | PET | PET | PET | PET | PET |
| | | Fineness (dtex) | 22 | 22 | 22 | 22 | 22 |
| | | Diameter (μm) | 45 | 45 | 45 | 45 | 45 |

| | | | | | | |
|---|---|---|---|---|---|---|
| | Diameter (D1) (μm) of conductive yarn | 109 | 109 | 109 | 229 | 229 |
| Insulating | Material for insulating yarns of front and back structures | CDP | CDP | CDP | CDP | CDP |
| yarn | Fineness (dtex) of insulating yarn | 56 | 84 | 167 | 56 | 84 |
| | Diameter (D2) (μm) of insulating yarn | 72 | 88 | 125 | 72 | 88 |

| Diameter ratio (D1/D2) | | 1.51 | 1.23 | 0.88 | 3.17 | 2.59 |
|---|---|---|---|---|---|---|
| Where conductive yams are knitted | | Front | Front | Front | Front | Front |
| | | structure | structure | structure | structure | structure |
| Number-of-yarns ratio (a/b) | | 1:4 | 1:4 | 1:4 | 1:4 | 1:4 |
| Surface quality | | + | + | + | + | + |
| Quick heating performance (sec) | | 78 | 83 | 87 | 33 | 36 |
| | | + | + | + | ++ | ++ |
| Stiffness (mm) | Lengthwise | 36 | 44 | 61 | 41 | 50 |
| | Crosswise | 35 | 41 | 59 | 40 | 52 |

| | | | | | |
|---|---|---|---|---|---|
| Surface followability | ++ | ++ | + | ++ | ++ |
| Bending durability | + | + | + | + | + |
| Wear resistance | + | + | + | + | + |
| Knittability | + | + | + | + | + |

TABLE 3

| | | | Example 11 | Example 12 | Example 13 | Example 14 | Example 15 |
|---|---|---|---|---|---|---|---|
| Conductive | Conductive | Material for metal wire | Cu/Si alloy | Cu/Si alloy | Cu/Si alloy | Cu/Si alloy | Cu/Si alloy |
| yarn | sheath yarn | Diameter of | 80 | 50 | 50 | 50 | 20 |
| | | metal wire (μm) | | | | | |
| | | Material for resin | Ester imide | Ester imide | Ester imide | Ester imide | Ester imide |
| | | Thickness of resin (μm) | 6 | 6 | 6 | 6 | 6 |
| | | Covering | Double | Double | Double | Double | Double |
| | | Electrical resistivity (Ω · m) | 2.47 × 10⁻⁷ | 2.47 × 10⁻⁷ | 2.47 × 10⁻⁷ | 2.47 × 10⁻⁷ | 2.47 × 10⁻⁷ |
| | Core yarn | Material | PET | PET | PET | PET | PET |
| | | Fineness (dtex) | 22 | 56 | 56 | 56 | 56 |
| | | Diameter (μm) | 45 | 72 | 72 | 72 | 72 |

| | | | | | | |
|---|---|---|---|---|---|---|
| | Diameter (D1) (μm) of conductive yarn | 229 | 196 | 196 | 196 | 136 |
| Insulating | Material for insulating yarns of front and back structures | CDP | CDP | CDP | CDP | CDP |
| yarn | Fineness (dtex) of insulating yarn | 167 | 56 | 84 | 167 | 56 |
| | Diameter (D2) (μm) of insulating yarn | 125 | 72 | 88 | 125 | 72 |

| Diameter ratio (D1/D2) | | 1.84 | 2.72 | 2.22 | 1.57 | 1.89 |
|---|---|---|---|---|---|---|
| Where conductive yarns are knitted | | Front | Front | Front | Front | Front |
| | | structure | structure | structure | structure | structure |
| Number-of-yarns ratio (a/b) | | 1:4 | 1:4 | 1:4 | 1:4 | 1:4 |
| Surface quality | | + | + | + | + | + |
| Quick heating performance (sec) | | 40 | 46 | 49 | 55 | 80 |
| | | ++ | ++ | ++ | ++ | + |
| Stiffness (mm) | Lengthwise | 73 | 42 | 50 | 70 | 39 |
| | Crosswise | 73 | 41 | 48 | 66 | 38 |

| | | | | | |
|---|---|---|---|---|---|
| Surface followability | + | ++ | ++ | + | ++ |
| Bending durability | + | + | + | + | + |
| Wear resistance | + | + | + | + | + |
| Knittability | + | + | + | + | + |

TABLE 4

| | | | Example 16 | Example 17 | Example 18 | Example 19 | Example 20 |
|---|---|---|---|---|---|---|---|
| Conductive | Conductive | Material for metal wire | Cu/Si alloy | Cu/Si alloy | Cu/Si alloy | Cu/Si alloy | Cu/Si alloy |
| yarn | sheath yarn | Diameter of | 20 | 20 | 80 | 80 | 80 |
| | | metal wire (μm) | | | | | |
| | | Material for resin | Ester imide | Ester imide | Ester imide | Ester imide | Ester imide |
| | | Thickness of resin (μm) | 6 | 6 | 6 | 6 | 6 |
| | | Covering | Double | Double | Double | Double | Double |
| | | Electrical resistivity (Ω · m) | 2.47 × 10⁻⁷ | 2.47 × 10⁻⁷ | 2.47 × 10⁻⁷ | 2.47 × 10⁻⁷ | 2.47 × 10⁻⁷ |
| | Core yarn | Material | PET | PET | PET | PET | PET |
| | | Fineness (dtex) | 56 | 56 | 56 | 56 | 56 |
| | | Diameter (μm) | 72 | 72 | 72 | 72 | 72 |

| | | | | | | |
|---|---|---|---|---|---|---|
| | Diameter (D1) (μm) of conductive yarn | 136 | 136 | 256 | 256 | 256 |
| Insulating | Material for insulating yarns of front and back structures | CDP | CDP | CDP | CDP | CDP |
| yarn | Fineness (dtex) of insulating yarn | 84 | 167 | 56 | 84 | 167 |
| | Diameter (D2) (μm) of insulating yarn | 88 | 125 | 72 | 88 | 125 |

| Diameter ratio (D1/D2) | | 1.54 | 1.09 | 3.55 | 2.90 | 2.05 |
|---|---|---|---|---|---|---|
| Where conductive yarns are knitted | | Front | Front | Front | Front | Front |
| | | structure | structure | structure | structure | structure |
| Number-of-yarns ratio (a/b) | | 1:4 | 1:4 | 1:4 | 1:4 | 1:4 |
| Surface quality | | + | + | + | + | + |
| Quick heating performance (sec) | | 85 | 89 | 36 | 39 | 42 |
| | | + | + | ++ | ++ | ++ |
| Stiffness (mm) | Lengthwise | 48 | 66 | 44 | 56 | 78 |
| | Crosswise | 45 | 63 | 41 | 54 | 76 |

| | | | | | |
|---|---|---|---|---|---|
| Surface followability | ++ | + | ++ | ++ | + |
| Bending durability | + | + | + | + | + |
| Wear resistance | + | + | + | + | + |
| Knittability | + | + | + | + | + |

TABLE 5

| | | | Example 21 | Example 22 | Example 23 |
|---|---|---|---|---|---|
| Conductive | Conductive | Material for metal wire | Cu/Si alloy | Nichrome | Cu/Ni alloy |
| yarn | sheath yam | Diameter of metal wire (μm) | 50 | 50 | 50 |
| | | Material for resin | Ester imide | Ester imide | Ester imide |
| | | Thickness of resin (μm) | 6 | 6 | 6 |
| | | Covering | Double | Double | Double |
| | | Electrical resistivity (Ω · m) | 2.47 × 10⁻⁷ | 1.5 × 10⁻⁶ | 4.9 × 10⁻⁷ |
| | Core yarn | Material | PET | PET | PET |
| | | Fineness (dtex) | 22 | 22 | 22 |
| | | Diameter (μm) | 45 | 45 | 45 |

| | | | | |
|---|---|---|---|---|
| | Diameter (D1) (μm) of conductive yarn | 169 | 169 | 169 |
| Insulating | Material for insulating yarns of front and back structures | Nylon | CDP | CDP |
| yarn | Fineness (dtex) of insulating yarn | 84 | 84 | 84 |
| | Diameter (D2) (μm) of insulating yarn | 97 | 88 | 88 |

| Diameter ratio (D1/D2) | | 1.74 | 1.91 | 1.91 |
|---|---|---|---|---|
| Where conductive yarns are knitted | | Front structure | Front structure | Front structure |
| Number-of-yarns ratio (a/b) | | 1:4 | 1:4 | 1:4 |
| Surface quality | | + | + | + |
| Quick heating performance (sec) | | 51 | 89 | 71 |
| | | ++ | + | + |
| Stiffness (mm) | Lengthwise | 38 | 44 | 44 |
| | Crosswise | 32 | 42 | 41 |

| | | | |
|---|---|---|---|
| Surface followability | ++ | ++ | ++ |
| Bending durability | + | + | + |
| Wear resistance | + | + | + |
| Knittability | + | + | + |

TABLE 6

| | | | Example 24 | Example 25 | Example 26 | Example 27 | Example 28 |
|---|---|---|---|---|---|---|---|
| Conductive | Conductive | Material for metal wire | Cu/Si alloy | Cu/Si alloy | Cu/Sn alloy | Cu/ Ag alloy | Cu/Sn alloy |
| yarn | sheath yarn | Diameter of | 50 | 50 | 70 | 55 | 70 |
| | | metal wire (μm) | | | | | |
| | | Material for resin | Polyurethane | Polyurethane | Polyurethane | Polyurethane | Polyurethane |
| | | Thickness of resin (μm) | 6 | 6 | 6 | 6 | 6 |
| | | Covering | Double | Double | Double | Double | Single |
| | | Electrical resistivity (Ω · m) | 2.47 × 10⁻⁷ | 2.47 × 10⁻⁷ | 6.84 × 10⁻⁸ | 1.59 × 10⁻⁸ | 6.84 × 10⁻⁸ |
| | Core yarn | Material | PET | PET | PET | PET | PET |
| | | Fineness (dtex) | 22 | 22 | 22 | 22 | 22 |
| | | Diameter (μm) | 45 | 45 | 45 | 45 | 45 |

| | | | | | | |
|---|---|---|---|---|---|---|
| | Diameter (D1) (μm) of conductive yarn | 169 | 169 | 209 | 179 | 127 |
| Insulating | Material for insulating yarns of front and back structures | CDP | CDP | CDP | CDP | CDP |
| yarn | Fineness (dtex) of insulating yarn | 56 | 84 | 84 | 84 | 84 |
| | Diameter (D2) (μm) of insulating yarn | 72 | 88 | 88 | 88 | 88 |

| Diameter ratio (D1/D2) | | 2.34 | 1.91 | 2.36 | 2.03 | 1.44 |
|---|---|---|---|---|---|---|
| Where conductive yarns are knitted | | Front | Front | Front | Front | Front |
| | | structure | structure | structure | structure | structure |
| Number-of-yarns ratio (a/b) | | 1:4 | 1:4 | 1:9 | 1:9 | 1:9 |
| Surface quality | | + | + | + | + | + |
| Quick heating performance (sec) | | 44 | 46 | 36 | 35 | 45 |
| | | ++ | ++ | ++ | ++ | ++ |
| Stiffness (mm) | Lengthwise | 37 | 44 | 68 | 45 | 42 |
| | Crosswise | 34 | 43 | 67 | 45 | 40 |

| | | | | | |
|---|---|---|---|---|---|
| Surface followability | ++ | ++ | ++ | ++ | ++ |
| Bending durability | + | + | + | + | + |
| Wear resistance | + | + | + | + | + |
| Knittability | + | + | + | + | + |

TABLE 7

| | | | Example 29 | Example 30 | Example 31 | Example 32 | Example 33 |
|---|---|---|---|---|---|---|---|
| Conductive | Conductive | Material for metal wire | Cu/Ag alloy | Cu/Sn alloy | Cu/Ag alloy | Cu/Sn alloy | Cu/Ag alloy |
| yarn | sheath yarn | Diameter of | 55 | 50 | 50 | 50 | 50 |
| | | metal wire (μm) | | | | | |
| | | Material for resin | Polyurethane | Polyurethane | Polyurethane | Polyurethane | Polyurethane |
| | | Thickness of resin (μm) | 6 | 6 | 6 | 6 | 6 |
| | | Covering | Single | Single | Single | Single | Single |
| | | Electrical resistivity (Ω · m) | 1.59 × 10⁻⁸ | 6.84 × 10⁻⁸ | 1.59 × 10⁻⁸ | 6.84 × 10⁻⁸ | 1.59 × 10⁻⁸ |
| | Core yarn | Material | PET | PET | PET | PET | PET |
| | | Fineness (dtex) | 22 | 22 | 22 | 56 | 56 |
| | | Diameter (μm) | 45 | 45 | 45 | 72 | 72 |

| | | | | | | |
|---|---|---|---|---|---|---|
| | Diameter (D1) (μm) of conductive yarn | 112 | 107 | 107 | 134 | 134 |
| Insulating | Material for insulating yarns of front and back structures | CDP | CDP | CDP | CDP | CDP |
| yarn | Fineness (dtex) of insulating yarn | 84 | 84 | 84 | 84 | 84 |
| | Diameter (D2) (μm) of insulating yarn | 88 | 88 | 88 | 88 | 88 |

| Diameter ratio (D1/D2) | | 1.27 | 1.21 | 1.21 | 1.52 | 1.52 |
|---|---|---|---|---|---|---|
| Where conductive yarns are knitted | | Front | Front | Front | Front | Front |
| | | structure | structure | structure | structure | structure |
| Number-of-yarns ratio (a/b) | | 1:9 | 1:9 | 1:9 | 1:9 | 1:9 |
| Surface quality | | + | + | + | + | + |
| Quick heating performance (sec) | | 44 | 66 | 49 | 67 | 51 |
| | | ++ | ++ | ++ | ++ | ++ |
| Stiffness (mm) | Lengthwise | 38 | 35 | 36 | 37 | 38 |
| | Crosswise | 36 | 34 | 34 | 37 | 37 |

| | | | | | |
|---|---|---|---|---|---|
| Surface followability | ++ | ++ | ++ | ++ | ++ |
| Bending durability | + | + | + | + | + |
| Wear resistance | + | + | + | + | + |
| Knittability | + | + | + | + | + |

TABLE 8

| | | | Comparative | Comparative | Comparative | Comparative | Comparative |
|---|---|---|---|---|---|---|---|
| | | | Example 1 | Example 2 | Example 3 | Example 4 | Example 5 |
| Conductive | Conductive | Material for metal wire | Cu/Si alloy | Cu/Si alloy | Cu/Si alloy | Cu/Si alloy | Cu/Si alloy |
| yarn | sheath yarn | Diameter of | 15 | 20 | 100 | 80 | 50 |
| | | metal wire (μm) | | | | | |
| | | Material for resin | Ester imide | Ester imide | Ester imide | Ester imide | Ester imide |
| | | Thickness of resin (μm) | 6 | 6 | 6 | 6 | 6 |
| | | Covering | Double | Double | Double | Double | Double |
| | | Electrical | 2.47 × 10⁻⁷ | 2.47 × 10⁻⁷ | 2.47 × 10⁻⁷ | 2.47 × 10⁻⁷ | 2.47 × 10⁻⁷ |
| | | resistivity (Ω · m) | | | | | |
| | Core yarn | Material | PET | PET | PET | PET | PET |
| | | Fineness (dtex) | 22 | 22 | 56 | 56 | 22 |
| | | Diameter (μm) | 45 | 45 | 72 | 72 | 45 |

| | | | | | | |
|---|---|---|---|---|---|---|
| | Diameter (D1) (μm) of conductive yarn | 99 | 109 | 296 | 256 | 169 |
| Insulating | Material for insulating yarns of front and back structures | CDP | CDP | CDP | CDP | CDP |
| yarn | Fineness (dtex) of insulating yarn | 167 | 220 | 56 | 33 | 84 |
| | Diameter (D2) (μm) of insulating yarn | 125 | 143 | 72 | 55 | 88 |

| Diameter ratio (D1/D2) | | 0.80 | 0.76 | 4.10 | 4.62 | 1.91 |
|---|---|---|---|---|---|---|
| Where conductive yarns are knitted | | Front | Front | Front | Front | Linking |
| | | structure | structure | structure | structure | yarns |
| Number-of-yarns ratio (a/b) | | 1:4 | 1:4 | 1:4 | 1:4 | 1:4 |
| Surface quality | | + | + | + | + | − |
| Quick heating performance (sec) | | 92 | 91 | 24 | 30 | 46 |
| | | − | − | ++ | ++ | ++ |
| Stiffness (mm) | Lengthwise | 59 | 74 | 48 | 42 | 46 |
| | Crosswise | 57 | 73 | 45 | 41 | 45 |

| | | | | | |
|---|---|---|---|---|---|
| Surface followability | + | + | ++ | ++ | ++ |
| Bending durability | + | + | + | − | + |
| Wear resistance | + | + | + | − | + |
| Knittability | − | + | − | + | + |

For all of the planar heat-generating knitted fabrics of Examples 1 to 33 in which the ratio (D1/D2) of the diameter (D1) of the conductive yarn and the diameter (D2) of the insulating yarn is 0.81 to 4.0, no sticking out was observed in any of the conductive yarns when the fabric was bent, which demonstrated excellent surface quality. For all of the planar heat-generating knitted fabrics of Examples 1 to 33, the time it took for the surface temperature to reach 65° C. was less than 90 seconds, which demonstrated excellent quick heating performance. Of them, for the planar heat-generating knitted fabrics of Examples 1 to 5, 9 to 14, 18 to 21, and 24 to 33 in which the diameter of the metal wire is at least 50 μm, the time it took for the surface temperature to reach 65° C. was less than 70 seconds, which demonstrated more excellent quick heating performance. For all of the planar heat-generating knitted fabrics of Examples 1 to 33, when the fabric was mounted and fixed along a trapezoidal box, no space was observed between the cloth and the box surface, which demonstrated excellent surface followability. For all of the planar heat-generating knitted fabrics of Examples 1 to 33, there was no break even when bending was performed 10000 times, which demonstrated excellent bending durability. For all of the planar heat-generating knitted fabrics of Examples 1 to 33, when the wear resistance of the fabric was tested, no break was observed in the surface, which demonstrated excellent wear resistance. For all of the planar heat-generating knitted fabrics of Examples 1 to 33, no break or irreversible bending of the conductive yarn was observed during knitting, which demonstrated excellent knittability. Thus, all of the planar heat-generating knitted fabrics of Examples 1 to 33 were excellent in all of surface quality, quick heating performance, bending durability, wear resistance, and knittability. The planar heat-generating knitted fabric of Example 21 in which the material for the insulating yarn is changed, and the planar heat-generating knitted fabrics of Examples 22 and 23 in which the material for the metal wire and the electrical resistivity of the conductive sheath yarn are changed, also had excellent quick heating performance, surface followability, bending durability, and knittability. The planar heat-generating knitted fabrics of Examples 24 and 25 in which the material for the resin in the conductive sheath yarn is changed, and the planar heat-generating knitted fabrics of Examples 26 to 33 in which the material for the resin in the conductive sheath yarn, and the material for the metal wire, the diameter of the metal wire, the electrical resistivity of the conductive sheath yarn, the type of the covering, and the fineness of the core yarn, are changed as appropriate, were also excellent in all of surface quality, quick heating performance, bending durability, wear resistance, and knittability.

In contrast to this, the planar heat-generating knitted fabrics of Comparative Examples 1 and 2 in which the ratio (D1/D2) is less than 0.81 had lower quick heating performance. Of the planar heat-generating knitted fabrics of Comparative Examples 1 and 2, in the planar heat-generating knitted fabric of Comparative Example 1 in which the metal wire has the smaller diameter, a break occurred in a conductive yarn during knitting, which demonstrated lower knittability. Of the planar heat-generating knitted fabrics of Comparative Examples 3 and 4 in which the ratio (D1/D2) is more than 4.0, in the planar heat-generating knitted fabric of Comparative Example 3 in which the metal wire in the conductive sheath yarn has the greater diameter, the conductive yarn was bent during knitting, which demonstrated lower knittability. The planar heat-generating knitted fabric of Comparative Example 4 in which the insulating yarn has the smaller diameter had lower bending durability and lower wear resistance. The results of Comparative Examples 3 and 4 demonstrated that not only the ratio (D1/D2) but also the diameter of the metal wire have an influence on knittability. In the planar heat-generating knitted fabric of Comparative Example 5 in which no conductive yarn is used in the front structure and back structure, and conductive yarns are used as the linking yarns, a conductive yarn stuck out from the surface when the fabric was bent, which demonstrated lower surface quality.

### INDUSTRIAL APPLICABILITY

The planar heat-generating knitted fabric and planar heat-generating body according to the present invention are usable in interior design articles for vehicles such as steering wheel heaters and seat heaters, clothing articles such as jackets, trousers, and globes, health and medical devices such as massage chairs and nursing care beds, furniture such as chairs and couches, and the like.

### REFERENCE SIGNS LIST

1 PLANAR HEAT-GENERATING BODY
10 PLANAR HEAT-GENERATING KNITTED FABRIC (HEAT-GENERATING PORTION)
10a ELECTRODE INSTALLATION REGION
20 ELECTRODE
100 LINKING YARN
201 FRONT STRUCTURE
202 BACK STRUCTURE
300 INSULATING YARN
400 CONDUCTIVE YARN
410 CORE YARN
420 CONDUCTIVE SHEATH YARN
421 METAL WIRE
422 INSULATING RESIN
D1 DIAMETER OF CONDUCTIVE YARN
D2 DIAMETER OF INSULATING YARN

What is claimed is:

1. A planar heat-generating knitted fabric comprising:
a knitted fabric including conductive yarns as a heat-generating portion, wherein
the conductive yarn has a core yarn, and a conductive sheath yarn wrapped around the core yarn,
the conductive sheath yarn is a metal wire covered with an insulating resin,
the knitted fabric is knitted in the form of a multilayer knitted fabric including a front and a back structure including insulating yarns as a base, the front and back structures being linked together by linking yarns,
the conductive yarns are knitted in at least one of the front and back structures, and
the ratio (D1/D2) of a diameter (D1) of the conductive yarn and a diameter (D2) of the insulating yarn is 0.81 to 4.0.

2. The planar heat-generating knitted fabric according to claim 1, wherein
in the conductive yarn, the conductive sheath yarn is wrapped around the core yarn with 100 to 1000 turns per meter of the core yarn.

3. The planar heat-generating knitted fabric according to claim 1, wherein
the conductive yarns are spaced apart from each other in the course or wale direction of the knitted fabric, and
the ratio (a:b) of the number (a) of the conductive yarns and the number (b) of the insulating yarns is 1:9 to 1:1.

4. The planar heat-generating knitted fabric according to claim 1, wherein
the core yarn has a fineness of at most 56 dtex.

5. The planar heat-generating knitted fabric according to claim 1, wherein
the conductive sheath yarn has an electrical resistivity of at most 5×10⁻⁵ Ω·m.

6. The planar heat-generating knitted fabric according to claim 1, wherein
the knitted fabric contains at least 5 wt % of the conductive sheath yarns.

7. The planar heat-generating knitted fabric according to claim 1, wherein
the front and back structures have the same type of structure.

8. A planar heat-generating body comprising:
the planar heat-generating knitted fabric according to claim 1; and
an electrode provided on the knitted fabric,
wherein
in a region of the planar heat-generating knitted fabric where the electrode is provided, the metal wire of the conductive sheath yarn is exposed by treatment of the conductive sheath yarn.
